(19) United States
(12) Patent Application Publication
(10) Pub. No.: US 2022/0364992 A1
(43) Pub. Date: Nov. 17, 2022

(54) SPECTRAL IMAGING SYSTEM AND METHOD FOR LOW SIGNAL DETECTION AND PROCESSING

(71) Applicants: STEPHEN STETSON, FALMOUTH, ME (US); LIAM STETSON, FALMOUTH, ME (US)

(72) Inventors: STEPHEN STETSON, FALMOUTH, ME (US); LIAM STETSON, FALMOUTH, ME (US)

(21) Appl. No.: 17/743,390

(22) Filed: May 12, 2022

Related U.S. Application Data
(60) Provisional application No. 63/188,169, filed on May 13, 2021.

(51) Int. Cl. G01N 21/64; G02B 27/14

(52) U.S. Cl. CPC G01N 21/6456; G02B 27/141; G01N 21/6486; G01N 2021/6463; G01N 2021/6421; G01N 2201/0826; G01N 2201/125; G01N 2021/1793

(57) ABSTRACT

Hardware and control software for use in the field of digital imaging and spectroscopy. More particularly, a hardware and software system that simultaneously measures electromagnetic energy as quantities of photons in distinct wavelength regions across the ultraviolet, visible, and infrared spectrum. The system records the measurements as digital data and employs a processor (preferably a programmable processor) that executes processing steps to enhance the spatial and spectral fidelity of the recorded signals. More specifically, the electro-optical sensor hardware is engineered to maximize the light collection efficiency, especially for low light intensities, by using multiple detectors, each of which is optimized individually to maximize its sensitivity to specific wavelength regions of interest. The detector system also employs a variable amplification process that is dependent on the signal intensity so that low signals can be increased for better detection while high signals are amplified less to stay within the dynamic range of the optical sensor that is used to convert the analog signal to a digital value. Solutions to existing problems of low light detection are provided as are new capabilities for data collection and analysis in previously undetectable low signal regimes. The systems and methods are applicable to a broad array of imaging applications in diverse fields from biomedical imaging to astronomy and remote sensing.

### FIELD OF THE INVENTION

The present invention relates generally to the field of digital imaging and spectroscopy. More particularly, the invention relates to a hardware and software system that measures electromagnetic energy as quantities of photons in distinct wavelength regions across the ultraviolet, visible, and infrared spectrum.

### BACKGROUND

Optical imaging technology is undergoing increasingly rapid advances in hardware and software. The evolution of sensor technology is expanding the range of new applications and improving the measurement capabilities within existing fields of use. The sensitivity of detectors, the spatial resolution, the spectral sensitivity, and the image acquisition speed are a few of the primary characteristics that are being advanced. In the race for newer technologies to be introduced, previous technologies are sometimes overlooked as users seek to stay on the forefront to address their imaging requirements. In some instances, however, previous technologies can be integrated with newer technologies in novel configurations to produce better solutions.

Earlier and evolving technologies must both address the same obstacles and challenges for optical imaging of detecting as much of the available light, or signal, from the target as possible, particularly the low signal intensity. Detecting the low signal intensity involves distinguishing the signal emitted from the target against two primary sources of interference, a) the background emissions from sources surrounding the target and b) the electronic Noise of the sensor system itself. A detector system's light collection efficiency is the first condition that determines if there is enough light reaching the sensor to produce a sufficient dynamic range in the recorded signal for effective image processing and data extraction to isolate the signal of interest. The electronic Noise characteristics of the system are the second condition.

At present there are perceived obstacles and challenges in measuring low light intensities that result in a low Signal to Noise Ratio (SNR) between the photon emissions from a source and the electronic Noise that is inherent in modern detector systems. An adequate SNR is essential for effective signal processing and data interpretation in imaging applications, particularly in low signal settings and single photon counting regimes.

Some of the current obstacles and challenges to measuring low light intensities at adequate SNR are caused by a reduced detection of photons from a target due to the following conditions:

A weak source of illumination on the target which results in the low intensity of photon emissions from the target.

Interference and attenuation of the photons between the target and the sensor caused by scattering, absorption, reflectance and/or other causes of signal reduction that may be found a) immediately surrounding the target, b) in the space between the target and the detector, and/or c) within the detector system due to the materials used in the optical components or the configuration of the optical components that channel the light to the sensor(s).

Short exposure periods that limit the number of photons that reach the sensor during the time allowed.

A reduction of the photons that reach a sensor results in more of the signal falling below the minimum detection threshold of the detector system. The minimum detection threshold is defined by the level of electronic Noise produced by the sensor in the form of dark current, read Noise and other sources of Noise that appear falsely as signal photons. The Noise from the sensor obscures low photon levels from a target amongst the apparent photon counts generated by the Noise.

Existing and previous multispectral and hyperspectral imaging systems cannot provide a suitable level of low light detection and dynamic range across a broad spectrum of ultraviolet, visible, and infrared wavelengths. Those systems without signal amplification depend on higher levels of light intensity to function. Those systems with signal amplification do not provide the same level of light collection efficiency and Noise reduction solutions compared to the current invention.

Other multispectral systems use beam splitters to channel the incoming light into separate paths regardless of wavelength, which results in a loss of signal intensity across the full spectrum by more than 50% at each beam splitter. Those systems then position a band pass filter in front of the sensor, which blocks unwanted wavelengths and allows certain wavelengths to pass through the filter. It is axiomatic that whenever light is split or blocked the signal is reduced, thereby limiting the SNR and the level of signal that can be detected.

Previous multi-sensor systems using image intensifiers or other forms of signal amplification use the same photocathode for each wavelength channel, thereby reducing the light collection efficiency of those systems compared to the current invention.

Previous multi-sensor systems using image intensifiers or other forms of signal amplification use a lens coupling system or tapered fiber optic connection between the phosphor screen of the image intensifier and the image sensor. These also limit the light collection efficiency compared to the current invention that uses a non-tapered fiber optic plate and other forms of collimated optics with waveguide technology to connect the phosphor to the sensor and maximize signal throughput.

### SUMMARY

The present invention overcomes the aforementioned obstacles. Embodiments of the invention include a hardware and software system that measures electromagnetic energy as quantities of photons in distinct wavelength regions across the ultraviolet, visible, and infrared spectrum. Embodiments of the invention obtain, record, and analyze measurements of electromagnetic energy as quantities of photons in distinct wavelength regions across the ultraviolet, visible, and infrared spectrum.

Embodiments include a multispectral sensor system comprising: an external housing for system components; a plurality of intensified image sensors and non-intensified image sensors; an optical assembly arranged within the interior of the external housing; an input aperture for collecting and channeling photons into the optical assemblies arranged within the interior of the external housing; input aperture optical elements for focusing an input beam of photons into the interior of the external housing through the aperture; and an optical assembly comprising dichroic mirrors and lenses for separating the input beam into a plurality of unique wavelength channels and directing each of the channels to a different sensor of the plurality of sensors. The sensors and optical assembly are designed to maximize the light collection efficiency of a unique range of wavelengths for each of the channels. Each intensified sensor comprises an intensifier and a sensor connected to each of the intensifiers with a photocathode that is optimized for its particular wavelength channel Each non-intensified sensor comprises an image sensor with a photocathode that is optimized for its particular wavelength channel.

In embodiments of the invention, each intensifier preferably includes a photocathode that converts the incoming photons to photoelectrons, one or more microchannel plates (MCP) that multiply the photoelectrons, and a phosphor screen that converts the multiplied photoelectrons back into photons. The choice of the photocathode for each intensifier is determined according to the wavelengths being measured. The choice of the number of MCPs and type of phosphor screen are determined according to a) the Noise in the selected sensor, b) the required frame rate of the photon measurements, and c) the technical application for the device.

Various sensors may be used depending on the technical application. For example, each sensor may comprise a single element sensor, a one-dimensional linear array sensor, or a two-dimensional image sensor.

The sensor measures the number of photons emitted from the phosphor screen and outputs a digital count. The digital count is preferably output to a digital processor for signal processing and analysis and then recorded on digital media. Software algorithms may be employed to enhance the spatial and spectral fidelity of the recorded signals.

Various designs may be used to ensure that photons are focused appropriately and consistently on the sensors. In one embodiment, all of the sensors are located such that the distance along the path from the focusing elements to the image sensor is equidistant for the plurality of sensors. In an alternative embodiment, the sensors are located such that the distance along the path from the focusing elements to the image sensor is not equidistant and optical elements, such as lenses, are used to focus photons on the sensors.

The input aperture optical elements may be in the form of a lens system or in the form of a fiber optic assembly in the form of either a single fiber or a fiber optic bundle, or in the form of a waveguide optical element that collimates the incoming stream of photons.

To minimize any reduction of signal intensity, dichroic mirrors are used to divide the input beam into separate channels, each channel comprising photons of a different and predetermined wavelength range. A dichroic mirror is a mirror with different reflection and transmission properties for different wavelengths. A dichroic mirror may be used as a high efficiency wavelength-dependent beam splitter.

The multispectral sensor system described herein may be used in various applications. In general, the method includes the steps of collecting photons from a subject area through the aperture of an external housing; channeling the photons within an optical assembly and using lenses and dichroic mirrors to separate the photons into a plurality of channels each having a unique range of wavelengths; directing each of the unique wavelength channels to a different sensor that is designed to maximize the light collection efficiency for the unique range of wavelengths for the respective channel; and for each channel using a sensor to convert an analog signal of photons to digital counts. The digital counts may be used to produce an image or to produce a spectral profile. As noted, the digital count is preferably output to a digital processor for signal processing and analysis and then recorded on digital media. A computer system records the measurements as digital data and, depending on the application, uses software algorithms to enhance the spatial and spectral fidelity of the recorded signals. Data analytics may be used to compare the recorded image data to previously stored data that is associated with known conditions to determine correlations between the newly measured data and previous data sets of known conditions.

In embodiments of the invention, the electro-optical sensor hardware is engineered to maximize the light collection efficiency, especially for low light intensities, by using multiple detectors, each of which is optimized individually to maximize its sensitivity to specific wavelength regions of interest. The detector system also employs a variable amplification process that is dependent on the signal intensity so that low signals can be increased for better detection while high signals are amplified less to stay within the dynamic range of the optical sensor that is used to convert the analog signal to a digital value. The invention solves many of the existing problems of low light detection in varying wavelengths and provides new capabilities for data collection and analysis in previously undetectable low signal regimes. The invention applies to a broad array of imaging applications in diverse fields from biomedical imaging to astronomy and remote sensing.

The present invention overcomes the obstacles and challenges of low SNR caused by the Noise of a detector system by several means, including maximizing the light collection efficiency and amplifying the signal with image intensifier technology and photocathode coating technology that is optimized separately for multiple sensors and different wavelength regions.

The optimum selection of detector components, including photocathode, microchannel plates, phosphor screen and image sensor, for different wavelengths, number of channels, incoming signal intensity and spatial resolution requirements, is essential to increasing the light collection efficiency and the SNR of the data.

The selection of photocathode for maximum light collection efficiency must balance a) the Quantum Efficiency of the photocathode substrate that converts incident photons to electrons, and b) the Noise generated from the photocathode in the form of thermionic emissions of electrons. In the current invention photocathodes with the lowest dark current and thermionic emission characteristics are chosen with consideration of the Quantum Efficiency of the photocathode substrate in order to produce the highest SNR from the photocathode.

The optical components are also selected and configured for maximum light collection efficiency. This includes the selection of materials and coatings used in lenses, mirrors, and in certain configurations, dispersion elements, which are optimized individually for each wavelength region that is channeled to a particular sensor.

Dichroic mirrors are used to separate the incoming light waves into different channels while maintaining the highest transmission and reflection efficiency possible.

The invention represents a novel approach to multispectral and hyperspectral imaging through its configuration of multiple image intensifier tubes and non-intensified sensors that are customized separately for enhanced sensitivity to different wavelength regions and controlled with a variable gain for different signal intensities. The system increases the range of photon measurements into the low signal levels that are unattainable by single sensor systems with or without signal amplification as well as multisensor systems that use the same photocathode on all sensors, or those using beam splitters and bandpass spectral filters instead of dichroic mirrors to separate channels.

The current invention's integration of components is critical to the adaptability of the multisensor system for different applications. Different applications require different numbers of sensors and involve different wavelength regions of interest. The current invention can be configured with any number of sensors tailored for the requirements of the application.

The present invention provides a multispectral sensor system that enables new methods of using multispectral imaging. One example is a medical imaging solution for the early detection of cancer. This safe and non-invasive screening protocol will detect and diagnose different forms of cancer and pre-cancerous conditions earlier and more accurately than existing methods. The screening procedure will serve as a digital optical biopsy, eliminating the need for surgical removal of cells and the time and expense of pathology lab examination. The digital measurements of suspected cancer can be collected in seconds using a multispectral sensor system. Data may be uploaded to a database for analysis that can diagnose and report the condition of the suspected tissue within minutes.

New capabilities include, but are not limited to, the following: biomedical imaging applications in, both, clinical and preclinical settings, biomedical sensing of single point photon emissions from fluorescent, bioluminescent, or chemiluminescent probes or labels, such as those used in surgical visualization, genetic sequencing, flow cytometry or other laboratory applications, astronomy applications involving simultaneous multispectral measurements of celestial objects, remote sensing from space-based and/or aerial platforms, and multispectral imaging in low-light settings for navigation, vision, virtual reality, and augmented reality applications.

### BRIEF DESCRIPTION OF DRAWINGS

FIG. 1 shows an exemplary configuration of a multi-sensor electro-optical detector system.

FIG. 1A shows a configuration in which the detectors are equidistant from the input.

FIG. 2 shows an exploded view of an intensifier system and sensor.

FIG. 3 shows a comparison of wavelength sensitivity and Noise of different photocathodes.

FIG. 3A shows another comparison of wavelength sensitivity and Noise of different photocathodes.

FIG. 3B shows another comparison of wavelength sensitivity and Noise of different photocathodes.

FIG. 4 schematically depicts exemplary connections of the sensors to a common circuit board where their data is transferred and stored for pre-processing

FIG. 5 shows a graph of the different Quantum Efficiency of three common phosphor screens.

FIG. 5A shows a graph of the different decay times for the photon emissions from three common phosphor screens.

### DETAILED DESCRIPTION

The invention includes embodiments of a multi-sensor electro-optical detector system designed to be the most sensitive electro-optical detector for measuring low levels of photon emissions across a broad spectrum of wavelengths simultaneously.

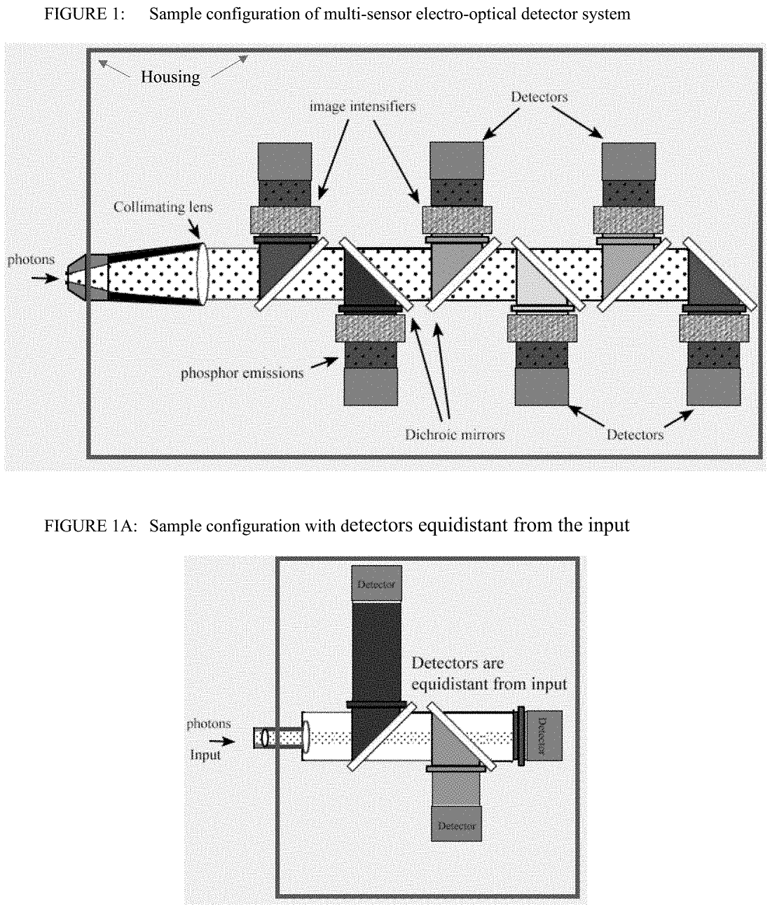

FIG. 1 is a schematic representation showing a configuration of a multi-sensor electro-optical detector system. The components shown in FIG. 1 are encased in a housing that is not shown. As shown in FIG. 1, an aperture, collimating lens, dichroic mirrors, and detectors (intensified and non-intensified sensors) are arranged such that the full spectrum of wavelengths is divided into a number of channels of different wavelength ranges, the number of channels depending on the application requirements.

In certain configurations the multispectral channels are further divided into hyperspectral channels by the use of dispersion elements positioned before the sensors.

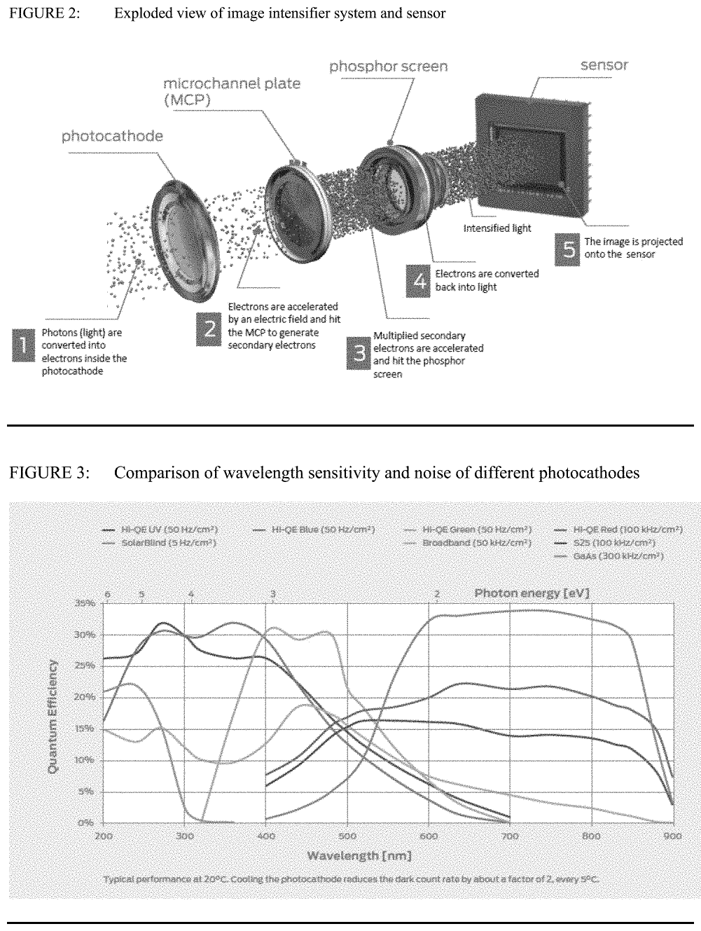

FIG. 2 shows an exploded view of an intensifier system and sensor. The main function of the intensifier is amplification of the incoming light signal by the multiplication of photoelectrons. The intensifier comprises the Photocathode, Microchannel plate (MCP) and a Phosphor screen, and the properties of these determine the performance of the intensifier. The photocathode converts the incoming photons to photoelectrons by collisional ionization. The photocathode is, therefore, directly behind the entrance window of the intensifier. When a photon strikes the frontside of the photocathode a photoelectron is emitted from the backside, which is then drawn towards the MCP by an electric field. The MCP is a thin disc (e.g., 1 mm thick) with a honeycomb of channels that are typically 6 μm wide, each with a resistive coating.

A high potential is applied across the MCP, enabling the photoelectron to accelerate down one of the channels in the disc. When the photoelectron has sufficient energy, it dislodges secondary electrons from the channel walls. These electrons in turn undergo acceleration which results in a cloud of electrons exiting the MCP. Gains in excess of 10,000 can readily be achieved with a single MCP. The degree of electron multiplication is controlled by the gain voltage applied across the MCP.

The sensitivity of photocathodes vary with wavelength. The efficiency with which a photocathode can convert an incident photon to a photoelectron is known as the photocathode's Quantum Efficiency (QE). The QE of each photocathode is one important property to consider when optimizing the different intensified sensors for a specific application.

The output of the intensifier is coupled to the sensor which may be a single element sensor, a one-dimensional linear array sensor, or a two-dimensional image sensor. The intensifier may be coupled to the sensor by a fiber optic plate or waveguide optical element. Using a straight fiber optic plate as opposed to a tapered fiber optic plate or lens system will increase the light collection efficiency of the intensified sensor.

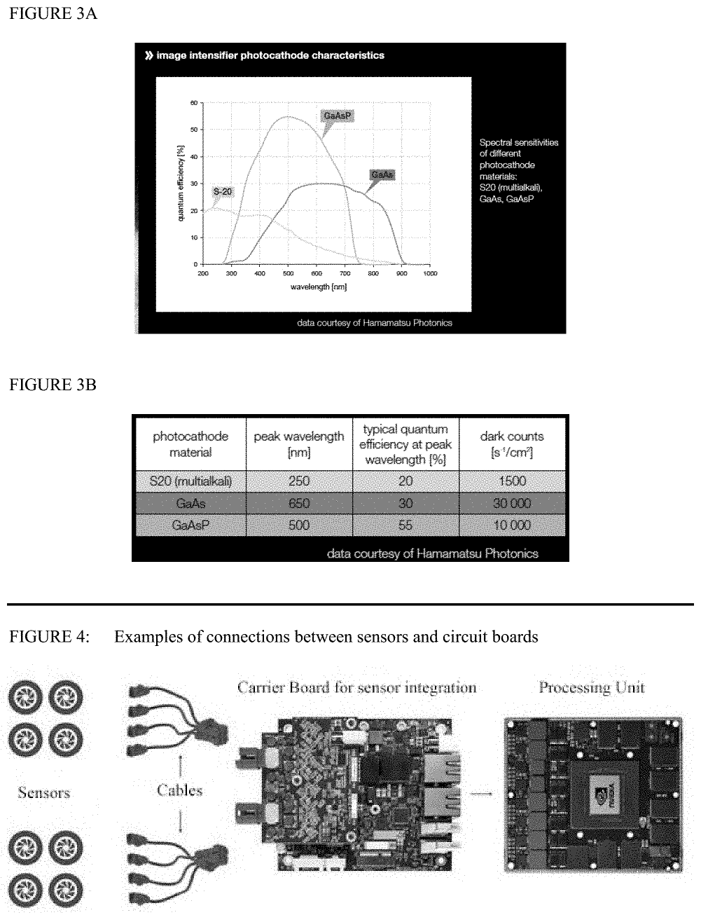

The novel configuration of multiple unique sensors, and the selection and configuration of optical components for channeling the incoming light to each intensified sensor, is designed to maximize the light collection efficiency at all wavelengths. As shown in FIG. 3, different types of photocathodes have different wavelength sensitivity profiles. Each sensor is uniquely configured for maximum sensitivity to different wavelength regions by selection of different photocathodes that convert incident photons into photoelectrons at the maximum ratio of Quantum Efficiency to Noise for the desired wavelengths.

The optical components include, but are not limited to, lenses, fiber optics, dichroic mirrors, and in certain configurations dispersion elements such as gratings or prisms. The materials used for each component are selected for maximum light collection efficiency in the specific wavelengths of the spectral channel involving the specific optical component.

The light is input to the housing enclosing the components of the system through an aperture comprising a lens or fiber optic assembly. The incoming light is separated into distinct wavelength channels by one or more dichroic mirrors. The number of mirrors is determined by the number of spectral channels that are required by the application.

The different channels of light are focused onto separate sensors. In the multispectral configurations the light is channeled onto the surface of a photocathode that is the first element of an image intensifier tube. In the hyperspectral configurations additional wavelength dispersion elements are positioned in front of the intensifier's photocathode.

The detector system incorporates image intensifier technology (FIG. 2) that is optimized individually for each sensor to increase the light collection efficiency of the specific wavelengths in each channel Different photocathode substrates are selected for each image intensifier according to the desired spectral range of its channel and its Noise characteristics. (FIG. 3).

To further increase the light collection efficiency of the detector system that employs two-dimensional (2-D) image sensors, the image sensors, which may be CMOS, sCMOS, CCD, multianode pint's, or other type of 2-D array optical sensor, may be fused to the output of the image intensifier's phosphor screen.

The sensors are connected to a common circuit board where their data is transferred and stored for pre-processing (FIG. 4). The pre-processed data is then transferred to an embedded processing unit for further data processing and analysis according to each application. FIG. 4 shows examples of components used in the detector system, including sensors, a carrier board for multi-sensor integration, cables to connect the sensors to the carrier board and a processing unit.

The multispectral sensor system measures and records the light intensity (brightness) in separate wavelength regions. The light intensity data for each wavelength range is obtained simultaneously so that the data for all of the wavelength ranges may be combined into an enhanced composite image in real-time. The composite image is enhanced by the hardware configuration because the components are each optimized to maximize light collection for their respective wavelength range. The composite image is further enhanced through data processing. The composite image is useful for analog visualization (human interpretation) while the digital data for each wavelength range allows improved, more accurate, low light measurements useful to improve applications such as cancer detection, medical imaging, remote sensing, and imaging of stars and other objects in astronomical observations.

As shown in FIGS. 3, 3A and 3B, available photocathodes use a variety of substrates that have different characteristics at different wavelengths. In accordance with the present invention, two characteristics are important in the selection of photocathodes for each wavelength range: Quantum Efficiency (sensitivity) and Noise. FIG. 3 depicts the Quantum Efficiency of various substrates at different wavelengths. The “Noise” or “dark count” for each substrate (at 20 degrees C.) is shown in parentheses at the top of the FIG. 3.

FIG. 3A shows the Quantum Efficiency of three additional photocathode materials at different wavelengths.

FIG. 3B provides additional information as to peak wavelength, Quantum Efficiency at peak wavelength, and dark counts (Noise) of the three photocathodes shown in FIG. 3A.

As described, the current invention overcomes the obstacles and challenges of low signal to Noise ratio (SNR) caused by the Noise of a detector system by several means, including maximizing the light collection efficiency and amplifying the signal with image intensifier technology that is optimized separately for multiple sensors and different wavelength regions.

Light collection efficiency and the SNR of the data are optimized by selecting detector components (photocathode, microchannel plates, phosphor screen and sensors) that perform best for the respective wavelengths, number of channels, incoming signal intensity, spatial resolution requirements and other criteria that may be application specific.

In particular, the selection of photocathode for maximum light collection efficiency must balance a) the Quantum Efficiency of the photocathode substrate that converts incident photons to photoelectrons, and b) the Noise generated from the photocathode in the form of thermionic emissions of electrons. In the current invention photocathodes with the lowest dark current and thermionic emission characteristics are chosen with consideration of the Quantum Efficiency of the photocathode substrate in order to produce the highest SNR from the photocathode.

The phosphor screen of the intensified sensors are available with different characteristics. The phosphor screen is selected to maximize the performance of each sensor for different applications according to the required rate of photon measurements and the intensity of photon levels.

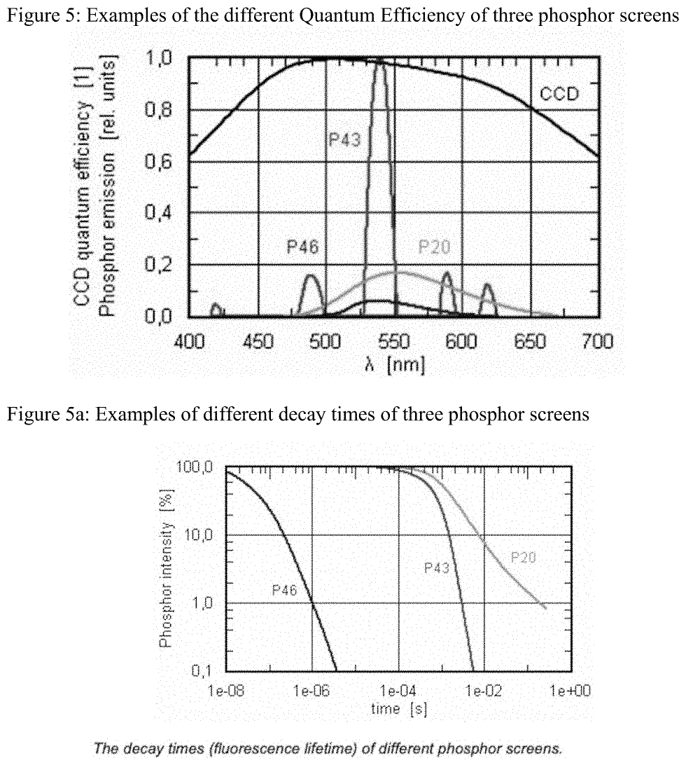

Three aspects of the phosphor screen are considered, including 1) the Quantum Efficiency at which the phosphor converts electrons to photons, 2) the peak wavelength of the photons emitted by the phosphor, and 3) the decay time of the phosphor emissions. Examples of these characteristics for several phosphor screens are illustrated in FIGS. 5 and 5a.

The present invention factors the characteristics of different phosphor screens to maximize the performance and the light collection efficiency of each intensified sensor for the specific application, operating environment, and wavelengths of interest.

The optical components are also selected and configured for maximum light collection efficiency. This includes the selection of materials and coatings used in lenses, mirrors, and in certain configurations, dispersion elements, which are optimized individually for each wavelength region that is channeled to a particular sensor.

Dichroic mirrors are used to separate the incoming light waves into different channels while maintaining the highest transmission and reflection efficiency possible. The photocathode element of each intensified sensor is selected to maximize the performance of each sensor in specific wavelength ranges, or channels. This is achieved primarily by maximizing the ratio between a) the Quantum Efficiency (QE) of the photocathode with b) the thermionic emissions and dark counts, or Noise, that are generated by the photocathode under varying operating conditions.

Additionally, in the selection of different photocathodes for each spectral channel consideration is given to the specific application for the device and the anticipated ambient operating environment. Ambient temperature impacts the Noise that is generated by the photocathode, as does the intensity of the incident photons from the subject being measured. Minimizing the Noise improves the performance of the sensor, and all contributing influences on the Noise must be calculated and factored into the photocathode selection.

The QE of photocathode substrates varies for each wavelength being measured. Therefore, if specific wavelengths of interest are predetermined for a specific application, then the ratio of a) the QE for the specific wavelengths to b) the expected Noise [QE for specific wavelengths: Noise] must be factored into the choice of each photocathode.

The current invention factors the above variables in the selection of each photocathode to maximize the performance and the light collection efficiency of each intensified sensor for the specific application, operating environment, and wavelengths of interest.

Information such as that shown in FIGS. 3-3B regarding the different characteristics of photocathode substrates at different wavelengths assists in calculating the ratio between QE and Noise.

FIG. 3 shows the Quantum Efficiency and Noise characteristics of eight different photocathode materials. Those skilled in the art will recognize that there are myriad possible combinations depending on the wavelengths of interest, the ratio of QE to Noise, the operating environment and the specific application, or use, for the device.

FIGS. 3A and 3B provide information regarding an additional three photocathode materials: S-20, GaAsP and GaAs. From the information provided, S-20 has the highest QE at the wavelengths from 200 nm to approximately 320 nanometers and has the least Noise. GaAsP has the highest QE from approximately 320 nanometers to 700 nanometers and has more Noise than S20. GaAs has the highest QE at wavelengths longer than 700 nanometers and has the highest level of Noise. Thus, in a multispectral intensified sensor system using these three photocathodes, and factoring only the ratio of QE to Noise, the shorter wavelengths up to 320 nanometers would be channeled to an S-20 photocathode, the wavelengths between 320 to 700 nanometers would be channeled to the GaAsP photocathode, and the longer wavelengths above 700 nanometers would be channeled to the GaAs photocathode.

Thus, for example, a multispectral intensified sensor system according to one embodiment of the invention would use distinct photocathodes for different wavelength ranges in separate channels.

Embodiments of the invention provide novel systems and methods for multispectral and hyperspectral imaging through its configuration of multiple image sensors that are customized separately for enhanced sensitivity to different wavelength regions and controlled with a variable gain for different signal intensities. Certain applications are made practical only because the system increases the range of photon measurements into the low signal levels that are unattainable by single sensor systems with or without signal amplification as well as multisensor systems that use the same photocathode on all sensors, or those using beam splitters and bandpass spectral filters instead of dichroic mirrors to separate channels.

As such, use of the system enables novel methods in various applications. Different applications require different numbers of sensors and involve different wavelength regions of interest. As described above, embodiments of the invention can be configured with any number of sensors tailored for the requirements of the application.

Applications for the multispectral sensor system described herein include (without limitation): biomedical imaging applications in, both, clinical and preclinical settings; biomedical sensing of single point photon emissions from fluorescent, bioluminescent, or chemiluminescent probes or labels, such as those used in genetic sequencing; flow cytometry or other laboratory applications; astronomy applications involving simultaneous multispectral measurements of celestial objects; remote sensing from space-based and/or aerial platforms; and multispectral imaging in low-light settings for navigation, vision, virtual reality, autonomous vehicle operation and augmented reality applications.

When used for these applications, the method includes the steps of collecting photons from a subject area through the aperture; channeling the photons within the housing and using lenses and dichroic mirrors to separate the photons into a plurality of channels each having a unique range of wavelengths; directing each of the unique wavelength channels to a different image sensor that is designed to maximize the light collection efficiency and Quantum Efficiency for the unique range of wavelengths for the respective channels; and for each channel using a sensor to convert an analog signal of photons to digital counts. The digital counts may be used to produce an image or to produce a spectral profile. The digital count is preferably output to a digital processor for signal processing and analysis and then recorded on digital media. An embedded computer processing unit records the measurements as digital data and, depending on the application, uses software algorithms to enhance the spatial and spectral fidelity of the recorded signals. Data analytics may be used to compare the recorded image data to previously stored image data that is associated with known conditions to determine correlations between the image data and known conditions.

The method of cancer detection using a multispectral sensor system that includes a plurality of sensors and optical assemblies arranged within the interior of a housing as described herein may further comprise the step of using the output digital counts to produce a spectral profile. In addition, the method may further comprise the step of outputting the digital counts to a processor for signal analysis to produce image data recorded on digital media and using data analytics to compare the recorded image data to previously stored image data that is associated with known conditions to determine correlations between the image data and known conditions.

Embodiments of the invention also include a method of genetic sequencing using a multispectral sensor system that includes a plurality of intensified sensors and optical assemblies arranged within the interior of a housing; an input aperture for collecting and channeling photons into the optical assemblies arranged within the interior of the housing; focusing elements for focusing an input beam of photons into the interior of the housing through the aperture; the method comprising the steps of: collecting photons from a subject through the aperture; channeling the photons within the housing and using lenses and dichroic mirrors to separate the photons into a plurality of channels each having a unique range of wavelengths; directing each of the unique wavelength channels to a different intensified sensor that is designed to maximize the light collection efficiency for the unique range of wavelengths for the respective channels; and for each channel using an intensified sensor to convert an analog signal of photons to digital counts.

Embodiments of the invention also include a method of flow cytometry using a multispectral sensor system that includes a plurality of intensified sensors and optical assemblies arranged within the interior of a housing; an input aperture for collecting and channeling photons into the optical assemblies arranged within the interior of the housing; focusing elements for focusing an input beam of photons into the interior of the housing through the aperture; the method comprising the steps of: collecting photons from a subject area through the aperture; channeling the photons within the housing and using dichroic mirrors and lenses to separate the photons into a plurality of channels each having a unique range of wavelengths; directing each of the unique wavelength channels to a different intensified sensor that is designed to maximize the light collection efficiency for the unique range of wavelengths for the respective channels; and for each channel using an intensified sensor to convert an analog signal of photons to digital counts.

Embodiments of the invention also include a method of using a multispectral sensor system in astronomy where the system includes a plurality of sensors and optical assemblies arranged within the interior of a housing; an input aperture for collecting and channeling photons into the optical assemblies arranged within the interior of the housing; focusing elements for focusing an input beam of photons into the interior of the housing through the aperture; the method comprising the steps of: collecting photons from a subject through the aperture; channeling the photons within the housing and using lenses and dichroic mirrors to separate the photons into a plurality of channels each having a unique range of wavelengths; directing each of the unique wavelength channels to a different intensified or non-intensified sensor that is designed to maximize the light collection efficiency for the unique range of wavelengths for the respective channels; and for each channel using a sensor to convert an analog signal of photons to digital counts.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

I claim:

1. A multispectral sensor system comprising:
an external housing for system components;
a plurality of intensified and non-intensified sensors and an optical assembly arranged within the interior of the external housing;
an input aperture for collecting and channeling photons into the optical assemblies arranged within the interior of the external housing;
input aperture optical elements for focusing an input beam of photons into the interior of the external housing through the aperture;
an optical assembly comprising lenses and dichroic mirrors for separating the input beam into a plurality of channels and directing each of the channels to a different sensor of the plurality of sensors;
wherein the sensors and optical assembly are designed to maximize the light collection efficiency of a unique range of wavelengths for each of the channels;
wherein the sensor measures the number of photons incident on the sensor and outputs a digital count;
wherein each intensified sensor comprising an image intensifier and a sensor;
wherein each intensifier comprising a photocathode that converts the incoming photons to photoelectrons, one or more a microchannel plates (MCP) that multiply the photoelectrons, and a phosphor screen that converts the multiplied photoelectrons back into photons.

2. The multispectral sensor system of claim 1, wherein the digital count is output to a digital processor for signal processing and analysis and then recorded on digital media.

3. The multispectral sensor system of claim 1, wherein each sensor comprises a single element sensor.

4. The multispectral sensor system of claim 1, wherein each sensor comprises a one-dimensional linear array sensor.

5. The multispectral sensor system of claim 1, wherein each sensor comprises a two-dimensional image sensor.

6. The multispectral sensor system of claim 1, wherein all of the sensors are located such that the distance along the path from the focusing elements to the image intensified sensor is equidistant for the plurality of sensors.

7. The multispectral sensor system of claim 1, wherein the sensors are located such that the distance along the path from the focusing elements to the image sensor is not equidistant and lenses are used to focus the photons on the sensors.

8. The multispectral sensor system of claim 1, wherein the input aperture optical elements comprise a lens system.

9. The multispectral sensor system of claim 1, wherein the input aperture optical element comprises a fiber optic assembly.

10. The multispectral sensor system of claim 1, wherein a fiber optic assembly or collimated waveguide assembly is fused between the sensor and the phosphor screen.

11. The multispectral sensor system of claim 1, wherein dichroic mirrors are used to divide the input beam into separate channels, each channel comprising photons of a different and predetermined wavelength range.

12. The multispectral sensor system of claim 1, wherein a different photocathode substrate is used for each of the different wavelength regions being measured as different channels of the detector system, the selection of photocathode substrate is made so as to maximize the sensitivity of each photocathode for its respective channel of specific wavelengths subject to consideration of dark counts.

13. The multispectral sensor system of claim 1, wherein a first photocathode substrate material is used for a shorter wavelength range and a second different photocathode substrate material is used for a longer wavelength range and wherein the first photocathode material has greater sensitivity than the second photocathode material in the first wavelength range and the second photocathode material would have greater sensitivity than the first photocathode material in the second wavelength range.

14. The multispectral sensor system of claim 1, wherein a first photocathode substrate material is used for a shorter wavelength range and a second different photocathode substrate material is used for a longer wavelength range, and at least one additional photocathode materials is used for at least one intermediate range; wherein the first photocathode material has greater sensitivity than the second photocathode material in the first wavelength range and the second photocathode material would have greater sensitivity than the first photocathode material in the second wavelength range and the at least one additional photocathode material has greater sensitivity in intermediate wavelength ranges.

15. A method of cancer detection using a multispectral sensor system that includes a plurality of sensors and optical assemblies arranged within the interior of a housing; an input aperture for collecting and channeling photons into the optical assemblies arranged within the interior of the housing; focusing elements for focusing an input beam of photons into the interior of the housing through the aperture; the method comprising the steps of:
collecting photons from a subject area through the aperture;
channeling the photons within the housing and using lenses and dichroic mirrors to separate the photons into a plurality of channels each having a unique range of wavelengths;
directing each of the unique wavelength channels to a different intensified sensor that is designed to maximize the light collection efficiency for the unique range of wavelengths for the respective channels; and
for each channel using an intensified sensor to convert an analog signal of photons to digital counts.

16. The method of claim 15, further comprising the step of intensifying each channel by using a photocathode that converts the incoming photons to photoelectrons, using one or more microchannel plates that multiply the photoelectrons, and using a phosphor screen that converts the multiplied photoelectrons back to photons.

17. The method of claim 15, further comprising the step of outputting the digital counts to a processor for signal analysis and recording on digital media.

18. The method of claim 15, further comprising the step of using the output digital counts to produce an image.

19. A method of fluorescence imaging using a multispectral sensor system that includes a plurality of sensors and optical assemblies arranged within the interior of a housing; an input aperture for collecting and channeling photons into the optical assemblies arranged within the interior of the housing; focusing elements for focusing an input beam of photons into the interior of the housing through the aperture; the method comprising the steps of:
collecting photons from a subject area through the aperture;
channeling the photons within the housing and using lenses and dichroic mirrors to separate the photons into a plurality of channels, each having a unique range of wavelengths;
directing each of the unique wavelength channels to different intensified and non-intensified sensors that are designed to maximize the light collection efficiency for the unique range of wavelengths for the respective channels; and
for each channel using a sensor to convert an analog signal of photons to digital counts.

20. A method of remote sensing from satellite and aerial platforms using a multispectral sensor system that includes a plurality of sensors and optical assemblies arranged within the interior of a housing; an input aperture for collecting and channeling photons into the optical assemblies arranged within the interior of the housing; focusing elements for focusing an input beam of photons into the interior of the housing through the aperture; the method comprising the steps of:
collecting photons from a subject area through the aperture;
channeling the photons within the housing and using lenses and dichroic mirrors to separate the photons into a plurality of channels each having a unique range of wavelengths;
directing each of the unique wavelength channels to a different intensified or non-intensified sensor that is designed to maximize the light collection efficiency for the unique range of wavelengths for the respective channels; and
for each channel using a sensor to convert an analog signal of photons to digital counts.
